(19) United States
(12) Patent Application Publication
(10) Pub. No.: US 2017/0149283 A1
(43) Pub. Date: May 25, 2017

(54) WIRELESS POWER-RELAY TRANSMISSION AND DISTANCE DISTRIBUTION SYSTEM

(71) Applicant: Sutherland Cook Ellwood, JR., Cookham (GB)

(72) Inventor: Sutherland Cook Ellwood, JR., Cookham (GB)

(21) Appl. No.: 15/186,404

(22) Filed: Jun. 17, 2016

Related U.S. Application Data
(60) Provisional application No. 62/181,143, filed on Jun. 17, 2015.

(51) Int. Cl. H02J 50/12; H02J 7/02

(52) U.S. Cl. CPC H02J 50/12; H02J 7/025

(57) ABSTRACT

A new wireless power-relay system suitable for any scale or distance of power transmission and distribution, whether in-building, inter-building, intra-city, or long-distance/inter-city, primarily based on low-frequency magnetic resonance field coupling, but alternatively based on low-frequency E-M waves; with multiple stages of non-interfering send-and-receive pairs that realizes a “power relay” process, structure and system, repeatable and extendable to any distance; and employing efficient shielding for highly-directed rather than omnidirectional field and wave emission; and finally and importantly, employing field and wave-guiding structures to increase efficiency and reduce cost in built and un-built environments.

### CROSS REFERENCE TO RELATED APPLICATIONS

This application claims benefit of U.S. Patent Application No. 62/181,143 filed 17 Jun. 2015, the contents of which are hereby expressly incorporated by reference thereto in its entirety for all purposes.

### FIELD OF THE INVENTION

The present invention relates generally to electrical energy and distribution thereof (also referred to as power transmission), but not exclusively, to wireless transfer of electrical energy and wireless systems, networks, equipment, and grids for distribution of electrical energy and power.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A concept of wireless power transmission has been proposed and realized in a wide variety of forms, for example by Nikola Tesla as exemplified in U.S. Pat. No. 645,576 (System of Transmission of Electrical Energy) and U.S. Pat. No. 649,621, Apparatus for Transmission of Electrical Energy, described new and useful combinations of transformer coils. The transmitting coil or conductor arranged and excited to cause currents or oscillation to propagate through conduction through the natural medium from one point to another remote point therefrom and a receiver coil or conductor of the transmitted signals. The production of currents of very high potential could be attained in these coils.

Wireless transfer of energy or power fundamentally may be achieved with radiative or non-radiative modes. Each of these modes includes limitations. Radiative includes energy transmission using an antenna (low-directionality or high-directionality). Low directionality is extremely inefficient for power transfer sufficient to power, charge, and operate remote electrical devices. High-directionality offers improvement in transfer efficiency but includes attendant complexity in alignment, tracking, and potential risks associated with intersecting a beam of energy from a transmitting antenna to a receiving antenna.

A non-radiative mode does not intentionally radiate energy but operates by having a primary oscillating magnetic near-field formed by a primary coil induce a current in a secondary nearby coil. While significant amounts of energy may be transferred in this mode, a required distance between the primary coil and the secondary coil is short which limits usefulness as an energy/power distribution system.

The prior art has seen advances in range extenders, sometimes referred to as repeaters, in which wireless power transfer is enabled over mid-range distances to improve non-radiative near-field wireless energy transfer. Coupled electro-magnetic resonators transfer power from a power supply to a power drain over medium range.

By contrast, the present disclosure focuses on improving the efficiency of power-relay within structures, as well as even more importantly, further extending the range of practical wireless power-relay between structures/buildings, to city-scale wireless power relay, to long-distance power relay, with efficiencies greater than conventional wired power distribution, greater safety, lower materials and operating costs and system construction costs comparable or less than the construction of modern telecom infrastructure networks.

What is needed is a system and method for increasing an efficiency of power distribution, increasing fault tolerance, and decreasing susceptibility to power outages, including outages from cascading failures from local accident or equipment failure, solar events, reducing dependence on rare metals, and improving safety and aesthetic design opportunities.

### BRIEF SUMMARY OF THE INVENTION

Disclosed is a system and method for increasing an efficiency of power distribution, increasing fault tolerance, and decreasing susceptibility to power outages, including outages from cascading failures from local accident or equipment failure, solar events, reducing dependence on rare metals, and improving safety and aesthetic design opportunities.

The following summary of the invention is provided to facilitate an understanding of some of the technical features related to non-radiative near-field wireless energy transfer, and is not intended to be a full description of the present invention. A full appreciation of the various aspects of the invention can be gained by taking the entire specification, claims, drawings, and abstract as a whole. The present invention is applicable to other wireless energy transfer mechanism and energy relay systems, and may employ other energy transfer technologies.

Some embodiments may include a significant extension of prior art systems to realize not a simple device-battery charger system but a complete, efficient wireless power distribution/relay system through the modules of the intelligent structural system, and enabling of wireless power distribution and access to other devices and systems which may not be “part” of an intelligent structural system, is described in the present disclosure.

It is a purpose of the present disclosure to extend wireless energy transfer systems to application in inter-building and in-fact long distance power distribution that has the prospect of an efficient, shielded, safe, and cost-effective power distribution architecture superior to the existing paradigm and familiar networks of solid conductive transmission lines and related power-substation and power-grid component and systems known to the art for over a hundred years.

A wireless relay including a plurality of wireless transfer segments, each segment including a begin energy transfer node and an end transfer node, a set of uniquely paired corresponding transfer nodes defined interface couplers where the segments are adjacent are constructed to have an energy transfer efficiency near, at, or greater than a transfer threshold and coupling efficiencies of all non-corresponding nodes is near, at, or below a non-transfer threshold.

In some embodiments, all the wireless transfer segments may be in series defining a single energy transfer path from a single energy source to a single energy drain. Intermediate couplers between transfer segments have a single end transfer node and a single begin transfer node, each having a unique correspondence with an appropriate one other transfer node of an immediately adjacent wireless transfer segment.

In some embodiments, one or more segments are parallelized, and couplers are illustrated having branching, merging, and/or switching capability to create, propagate, and terminate parallel wireless transfer paths.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a wireless energy transfer system;

FIG. 2 illustrates an initiation coupler as part of the wireless energy transfer system illustrated in FIG. 1;

FIG. 3 illustrates an intermediate coupler as part of the wireless energy transfer system illustrated in FIG. 1;

FIG. 4 illustrates a termination coupler as part of the wireless energy transfer system illustrated in FIG. 1;

FIG. 5 illustrates a branching coupler as part of an alternative wireless energy transfer system;

FIG. 6 illustrates a merging coupler as part of an alternative wireless energy transfer system;

FIG. 7 illustrates an alternative coupler as part of an alternative wireless energy transfer system;

FIG. 8 illustrates a set of three intermediate couplers forming a portion of a wireless relay; and

FIG. 9 illustrates a shielded implementation of a set of three intermediate couplers forming a portion of a shielded wireless relay.

### DETAILED DESCRIPTION OF THE INVENTION

Embodiments of the present invention provide a system and method for increasing an efficiency of power distribution, increasing fault tolerance, and decreasing susceptibility to power outages, including outages from cascading failures from local accident or equipment failure, solar events, reducing dependence on rare metals, and improving safety and aesthetic design opportunities. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### DEFINITIONS

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

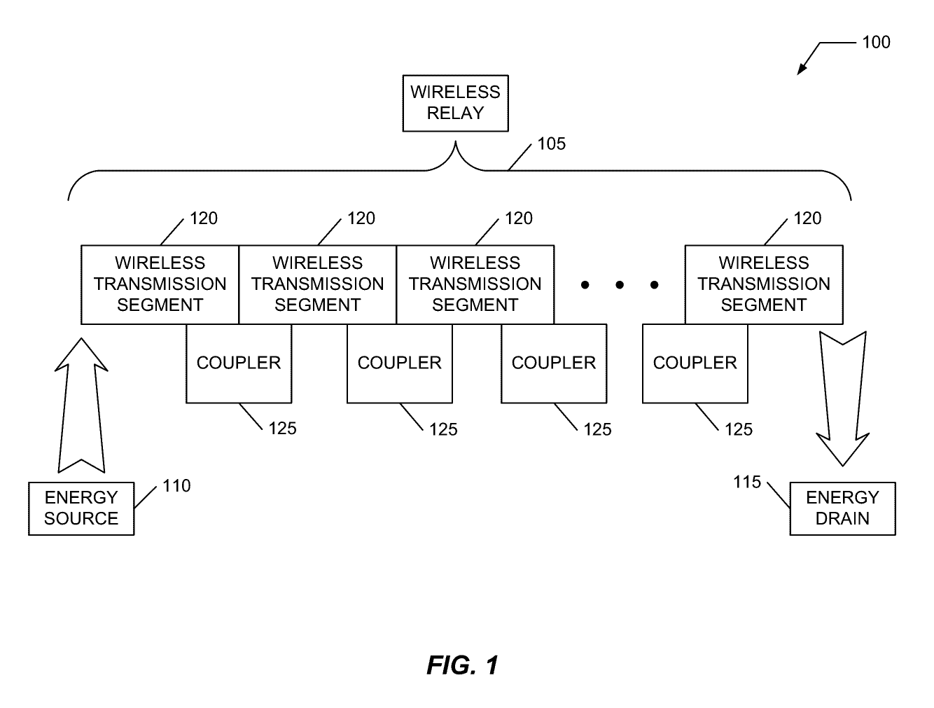

FIG. 1 illustrates a wireless energy transfer system 100. System 100 includes a wireless relay 105 that transfers energy from an energy source 110 to an energy drain 115. Relay 105 includes a series of wireless transmission segments 120 having a coupler 125 at an interface between segments 120. System 100 is designed to transfer energy, or distribute power, from energy source 110 to energy drain 115 through an ambient environment without interaction—in some embodiments this is a targeted one-to-one transfer from energy source 110 to energy drain 115. This is contrast to a range extender or repeater that extends an effective power transfer range to include more devices within the ambient environment around an energy source. Energy source 110 may include one or more sources of energy, including for example line energy from an electrical power distribution grid, and/or stored energy from a battery, ultracapacitor, or the like.

As illustrated, each segment 120 operates using near-field energy coupling that is tailored to maximize energy transfer from a begin node to an end node. Each begin node is designed and intended to be decoupled, within operational parameters and application conditions, from all but one end node of system 100. Further, each end node is designed and intended to be decoupled, within operation parameters and application conditions, from all but one begin node. A wireless transmission technology used by a segment 120 has a limited effective distance, effective in this context refers to a coupling efficiency which affects how much energy is transferred from a begin node to an end node. System 100 includes a set of segments 120 that are designed to wirelessly transfer energy in a one-to-one relationship of begin to end of corresponding nodes. An energy transfer efficiency between non-corresponding nodes is established to be less than a predetermined threshold, that threshold balancing many factors but ultimately effecting an energy transfer throughput of relay 105 when communicating energy from source 110 to drain 115.

Relay 105 is able to effectively use different wireless energy transfer technologies and methodologies, and in some implementations, a hybrid system 100 may include different, but compatible, energy transfer technologies in individual segments 120. Some embodiment include a requirement that, for whatever wireless transfer technology is used, such near-field wireless transfer, there be an intended one-to-one correspondence between a begin node and an end node—the transfer characteristics and parameters effectively, within the desired level of efficiency, communicating energy from the begin node to the end node only.

Couplers 125 provide for an interface between adjacent segments 120 bridging energy communication between them. As illustrated, each coupler 125 includes an end node of an adjacent upstream segment, a regenerator, and a begin node of an adjacent downstream segment. The end node uses a transfer framework compatible with a begin node of a particular adjacent upstream segment (in a case where there are multiple upstream segments) to uniquely receive (i.e., the only intended receiver from a particular node) energy communicated from this begin node. The end node uses a transfer framework compatible with an end node of a particular adjacent downstream segment (in a case where there are multiple downstream segments) to uniquely transmit (i.e., the only intended transmitter to a particular node) energy communicated from this end node. The regenerator, coupled to all the nodes of its coupler 125, receives energy from the end node(s) and processes it for transmission to begin node(s).

For example, in some implementations using non-radiative near-field electromagnetic transfer, resonators are used at each node of each coupler 125. The resonators of corresponding unique pairs of begin and end nodes are designed and selected to interact with each other under resonance conditions. The resonators of non-corresponding pairs of nodes (whether begin and/or end nodes) are designed and selected so that they do not interact with each other, within a level of wireless transfer performance preselected for the system and/or process. A measure of the resonance conditions sometimes employs a coupling coefficient and/or a Q-factor. Some embodiments provide corresponding unique pairs of begin and end nodes with coupling coefficients and/or Q-factors above a transfer threshold for efficient energy transfer between the nodes. Further, some embodiments provide non-corresponding pairs of nodes with coupling coefficients and/or Q-factors below a non-transfer threshold for extremely inefficient energy transfer (if any) between the non-corresponding nodes. System 100 provides for both—highly efficient energy transfer between corresponding unique begin and end node pairs and highly inefficient energy transfer between non-corresponding node pairs, energy transfer pathways from an energy source to an energy drain are defined between a series of successive linked corresponding unique node pairs.

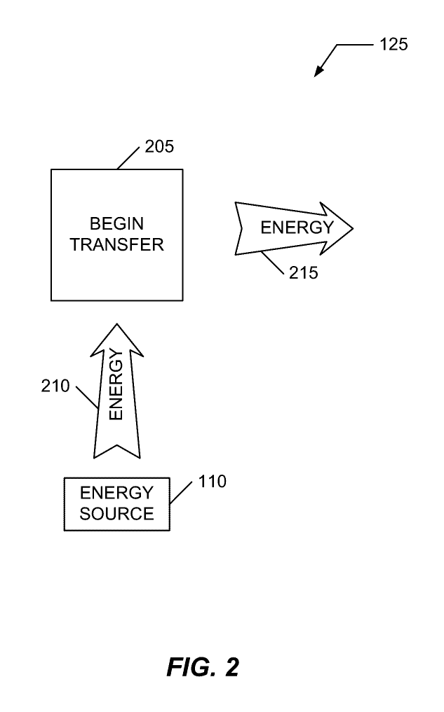

FIG. 2 illustrates an initiation coupler 125 as part of wireless energy transfer system 100. Coupler 125 of FIG. 2 includes one (or more) begin transfer nodes 205. Each begin transfer node 205 is coupled to an energy source 110 and provides an energy supply 210 (typically wired but may be some wireless energy transfer protocol) to begin transfer node 205. Begin transfer node 205 creates a wireless energy transfer 215 as a beginning of an initial wireless transfer segment 120. As noted herein, the specifics of begin transfer node 205 (and consequently wireless energy transfer 215) may vary based upon application and technology framework. For example, begin transfer node 205 may employ a near-field resonator (e.g., an electric resonator or a magnetic resonator) with a particular Q-factor. In system 100, the initial wireless transfer segment 120 has an adjacent wireless segment joined by an intermediate coupler 125.

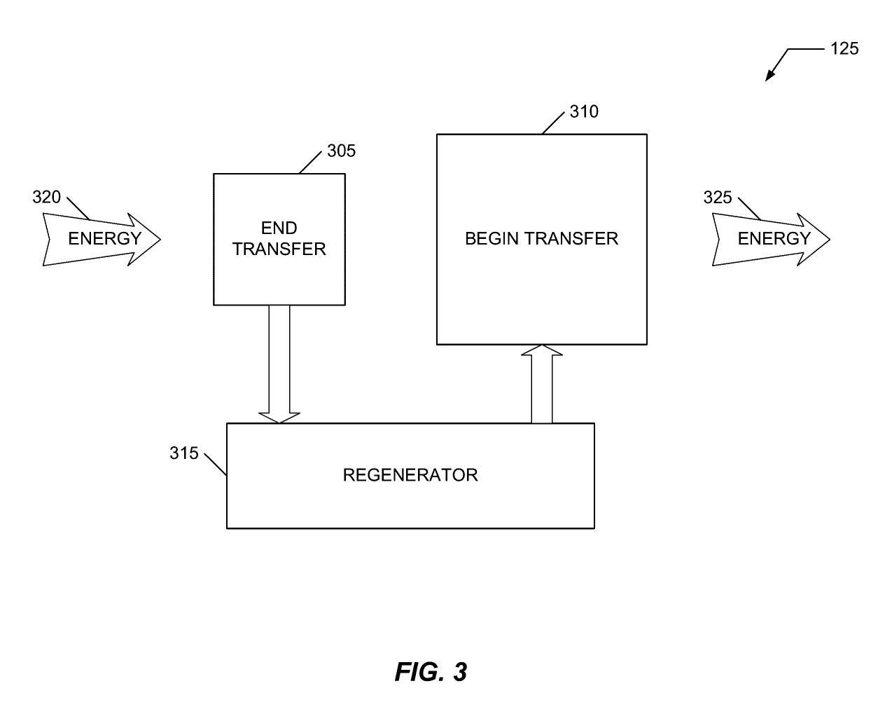

FIG. 3 illustrates an intermediate coupler 125 as part of wireless energy transfer system 100. Intermediate coupler 125 of FIG. 3 includes an end transfer node 305, a begin transfer node 310, and a regenerator 315. Each intermediate coupler 125 is an interface between an immediately adjacent upstream wireless transmission segment 120 and an immediately adjacent downstream wireless segment 120. End transfer node 305 receives wireless a wireless energy transfer 320 (e.g., wireless energy transfer 215 when intermediate coupler 125 of FIG. 3 is coupled to initiation coupler 125 of FIG. 2) from only a begin transfer node of a particular one immediately adjacent upstream wireless transfer segment 120. End transfer node 305 and begin transfer node 205 at this interface define a corresponding unique pair of begin and end nodes. End transfer node 305 is compatible with its corresponding uniquely paired begin node such that wireless energy transfer 320 is provided only from the paired begin node and similarly wireless energy transfer 215 is provided only to the corresponding paired end transfer node 305. When begin transfer node 205 includes a resonator of a particular Q-factor, corresponding end transfer node 305 has a compatible resonator of a matching Q-factor to provide a coupling efficiency at or above the desired transfer efficiency.

Begin transfer node 310 produces a wireless energy transfer 325 at a beginning of the immediately adjacent downstream wireless segment 120. Begin transfer node 310 transmits wireless a wireless energy transfer 325 to only an end transfer node of a particular one immediately adjacent downstream wireless transfer segment 120. Begin transfer node 310 and one end transfer node of this particular one immediately adjacent downstream wireless transfer segment define another corresponding unique pair of begin and end nodes. Begin transfer node 310 is compatible with its corresponding uniquely paired end node such that wireless energy transfer 325 is provided only to the paired end transfer node. Begin transfer node 310 may include a resonator of a particular Q-factor. The uniquely corresponding paired end transfer node may include a compatible resonator of a matching Q-factor to provide a coupling efficiency at or above the desired transfer efficiency. When end transfer node 305 also includes a resonator with a Q-factor, the Q-factor of begin transfer node 310 will have a different Q-factor that provides a coupling efficiency at or below the non-transfer threshold to have no or extremely inefficient transfer of energy 320 from begin transfer node 205 of FIG. 2.

Regenerator 315 is coupled to end transfer node 305 to receive energy from wireless energy transfer 320. Regenerator 315 processes (including conversion, switching, and regulation) this received energy to provide transmission energy to begin transfer node 310 for production of wireless energy transfer 325. Regenerator 315 is self-contained and is powered from energy received by end transfer node(s) that are part of the same coupler 125.

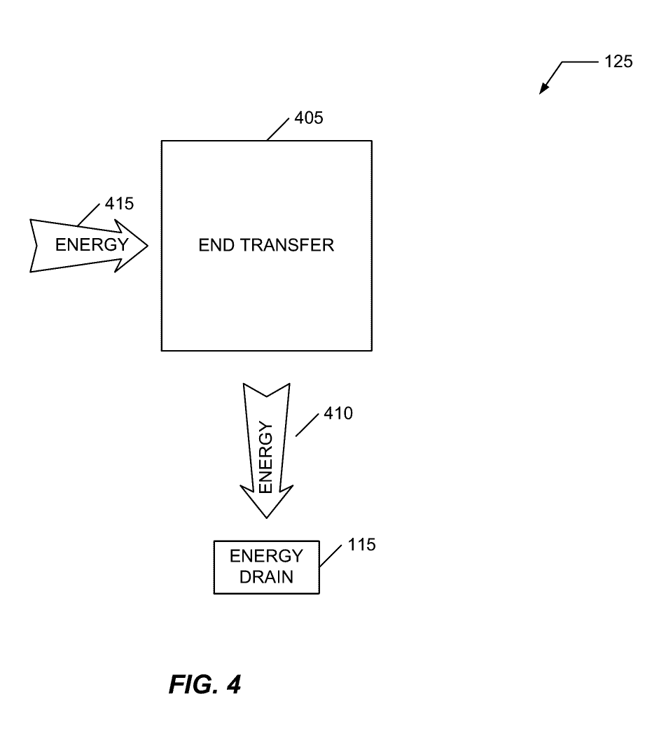

FIG. 4 illustrates a termination coupler 125 as part of wireless energy transfer system 100.

Coupler 125 of FIG. 4 includes one (or more) end transfer nodes 405. Each end transfer node 405 is coupled to an energy drain 115 and provides an energy supply 410 (typically wired but may include in addition to, or in lieu of, a wireless energy transfer protocol) from end transfer node 405. End transfer node 405 terminates a wireless energy transfer 415 as a termination of a final wireless transfer segment 120. As noted herein, the specifics of end transfer node 405 (and consequently wireless energy transfer 415) may vary based upon application and technology framework. For example, end transfer node 405 may employ a near-field resonator (e.g., an electric resonator or a magnetic resonator) with a particular Q-factor. In system 100, the final wireless transfer segment 120 is coupled to an adjacent upstream wireless segment joined by an intermediate coupler 125. Energy transfer coupling efficiency of end transfer node 405 is designed and intended to be above the transfer threshold with respect to a single particular one corresponding uniquely paired begin transfer node of a immediately adjacent upstream wireless transfer segment 120 and below the non-transfer threshold for all other nodes of system 100.

In one embodiment, system 100 includes an initial segment 120, one or more intermediate segments 120, and a termination segment 120. These segments define a single series of segments, each having an appropriate coupler at its interface to each immediately adjacent segment. The nodes of each coupler have a unique corresponding pairing such that efficient transfer coupling from any one node is matched to at most one other node. Each node has a coupling efficiency with respect to all other non-corresponding nodes at or below the non-transfer threshold. In this fashion, system 100 efficiently wirelessly relays energy from energy source 110 to energy drain 115 through segments 120 of wireless relay 105.

When system 100 is implemented using resonators, each node of a corresponding pair includes a pair of resonators of matching Q-factor while other resonators within range have different Q-factors to maintain its coupling efficiency with non-corresponding nodes near, at, or below the non-transfer threshold. Depending upon the implementation details of each wireless transfer segment 120 and of all segments 120 of system 100, sufficiently distant or isolated segments may be able to reuse resonators of a particular Q-factor as long as the coupling efficiency of all non-corresponding nodes is near, at, or below the non-transfer threshold, as determined by the application and implementation requirements. While it may not be possible to make the coupling of non-corresponding node effectively zero, it is possible with proper design and implementation details to reduce the coupling efficiency to levels that are not significant for the implementation. This is a non-intended coupling that is reduced and/or eliminated appropriately with an intended and designed coupling and energy transfer occurring only between corresponding energy transfer nodes at segment interfaces between immediately adjacent wireless transfer segments.

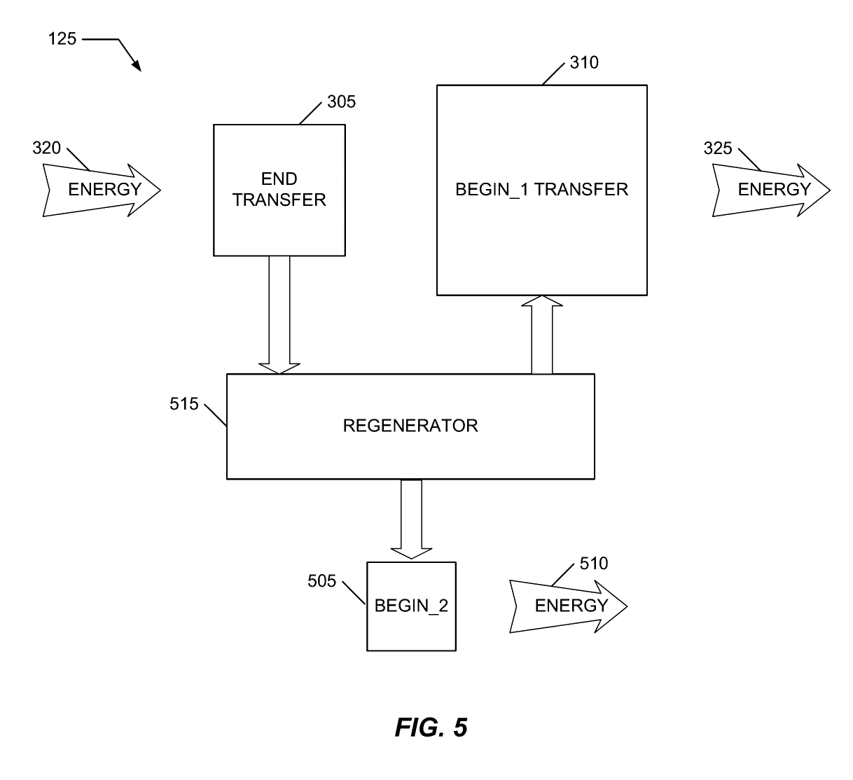

FIG. 5 illustrates a branching intermediate coupler 125 as part of an alternative wireless energy transfer system 100. FIG. 1 illustrates an embodiment for system 100 in which all wireless transfer segments 120 are in series. This arrangement provides an efficient wireless energy relay between a distant (greater than a distance of a single wireless transfer segment) pair of energy source 110 and energy drain 115. In some embodiments, one or more wireless transfer segments 120 are in parallel to one or more other wireless transfer segments 120, such as for an energy source to drive multiple discrete remote energy drains or for redundancy over some or all of the transmission path of relay 105. For this parallelization to occur, branching intermediate coupler 125 is used to produce two or more wireless energy transfers. Branching intermediate coupler 125 of FIG. 5 corresponds to intermediate coupler 125 of FIG. 3 with the addition of a second begin transfer node 505 producing a second wireless energy transfer 510 to a second immediately adjacent downstream wireless transfer segment. Regenerator 515 is modified to operate with both begin transfer nodes.

Second begin transfer node 505, like all other transfer nodes of system 100, preferably includes a unique correspondence to a single particular one end transfer node of the second immediately adjacent downstream wireless transfer segment. This unique correspondence also preferably provides a coupling efficiency between these nodes near, at, or above the transfer threshold and all other coupling efficiencies of these nodes to non-corresponding nodes is near, at, or below the non-transfer threshold.

Regenerator 515, in addition to its operation similar to regenerator 315 of FIG. 3, is also coupled to second begin transfer node 505. Regenerator 515 receive energy from wireless energy transfer 320. Regenerator 515 processes (including conversion, switching, and regulation) this received energy to provide transmission energy to first begin transfer node 310 for production of first wireless energy transfer 325 to a first immediately adjacent downstream wireless transfer segment 120 and provides transmission energy to second begin transfer node 505 for production of second wireless energy transfer 510 to a second immediately adjacent downstream wireless transfer segment 120. Regenerator 515 is self-contained and is powered from energy received by end transfer node(s) that are part of the same coupler 125.

Regenerator 515 has one or more operational modes that may include a predetermined mode and a dynamic mode. In the predetermined mode, regenerator 515 provides a fixed or predetermined energy split ratio between its begin transfer nodes (there may be more than the two illustrated begin nodes at a branching intermediate coupler) such as 50/50 between each of two immediately adjacent downstream wireless transfer segments. In the dynamic mode, regenerator 515 may variably set ratios in response to control signal input. In a predetermined mode, regenerator 515 may include multiple different predetermined ratios and a decision mechanism by which regenerator 515 selects and implements one of the different ratios. The decision mechanism may be based upon a timer, clock, or input control signal such that upon occurrence of a predetermined event, a particular one or a particular different one of the predetermined ratios is selected. For example, the predetermined ratios for a two segment branching coupler 125 could have three values: 100/0, 50/50, 0/100, 0/0, X/0, 0/X (0<X<100%) corresponding to energy level percent for each immediately adjacent downstream segment. Periodically upon expiration of a timer, or upon activation of a time of day, or upon receipt of a control signal, the ratio is changed from one ratio to another in a predetermined manner. In the dynamic mode, the ratios are not prestored but are communicated from outside regenerator 515.

The control signal may be a separate input signal, such a wireless control signal transmitted to a wireless receiver within branching intermediate coupler 125, or sent via wireless energy transfer 320. The control sent via wireless energy transfer 320 may be in-band or out-band. For example, a control command may be signaled by a series of voltage levels in a predetermined pattern may identify a particular one ratio or provide an increment signal to switch ratios. Alternatively an embedded control signal may be decoded for control of regenerator 515. Regenerator 515 may include an energy buffer, e.g., a capacitor or other energy storage device, to reduce any unintended output energy fluctuations when energy levels of the input wireless energy transfer is modulated for input/control. Initial coupler 125 such as illustrated in FIG. 2 may also be modified to include a branching capability as described herein.

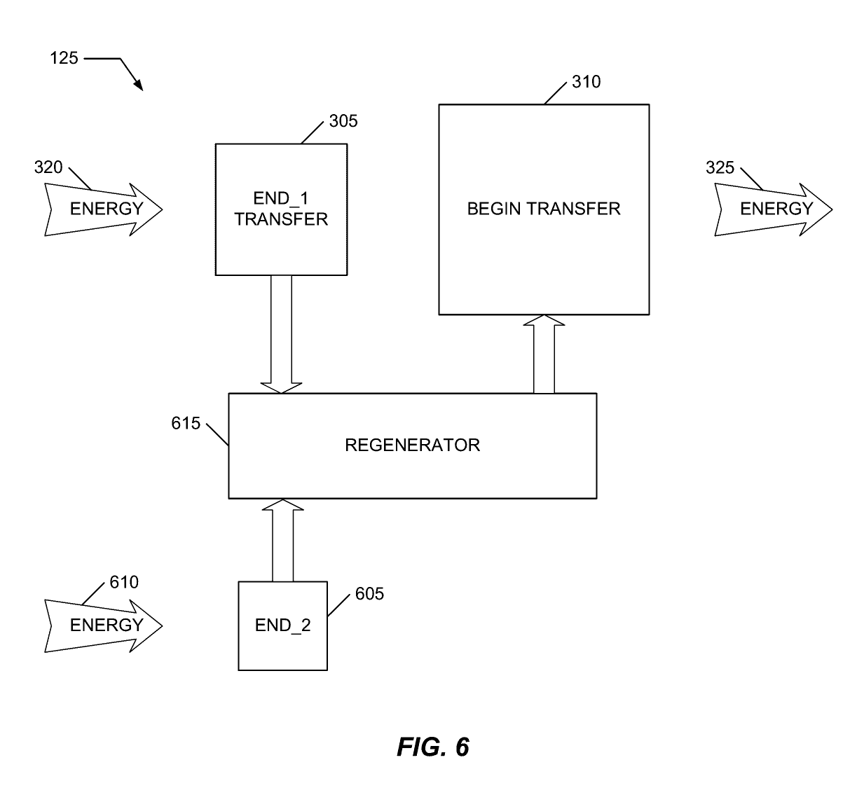

FIG. 6 illustrates a merging intermediate coupler 125 as part of an alternative wireless energy transfer system 100. Merging intermediate coupler 125 serializes multiple parallel immediately adjacent upstream wireless transfer segments 120 into a single immediately adjacent downstream wireless transfer segment 120. Merging intermediate coupler 125 of FIG. 6 is similar to intermediate coupler 125 illustrated in FIG. 3 with the addition of an end transfer node 605 for each additional immediately adjacent upstream wireless transfer segment 120. Each additional immediately adjacent upstream wireless transfer segment includes an additional wireless energy transfer 610 transmitted by a begin transfer node.

Each additional begin transfer node of a coupled immediately adjacent upstream wireless transfer segment, like all other transfer nodes of system 100, preferably includes a unique correspondence to a single particular one end transfer node 605 of merging intermediate coupler 125. This unique correspondence also preferably provides a coupling efficiency between these nodes near, at, or above the transfer threshold and all other coupling efficiencies of these nodes to non-corresponding nodes is near, at, or below the non-transfer threshold. In some implementations, all end transfer nodes may match and couple non-uniquely, such as to merge all input wireless energy transfers into a single wireless energy transfer 325. Termination coupler 125 such as illustrated in FIG. 4 may also be modified to include a merging capability as described herein.

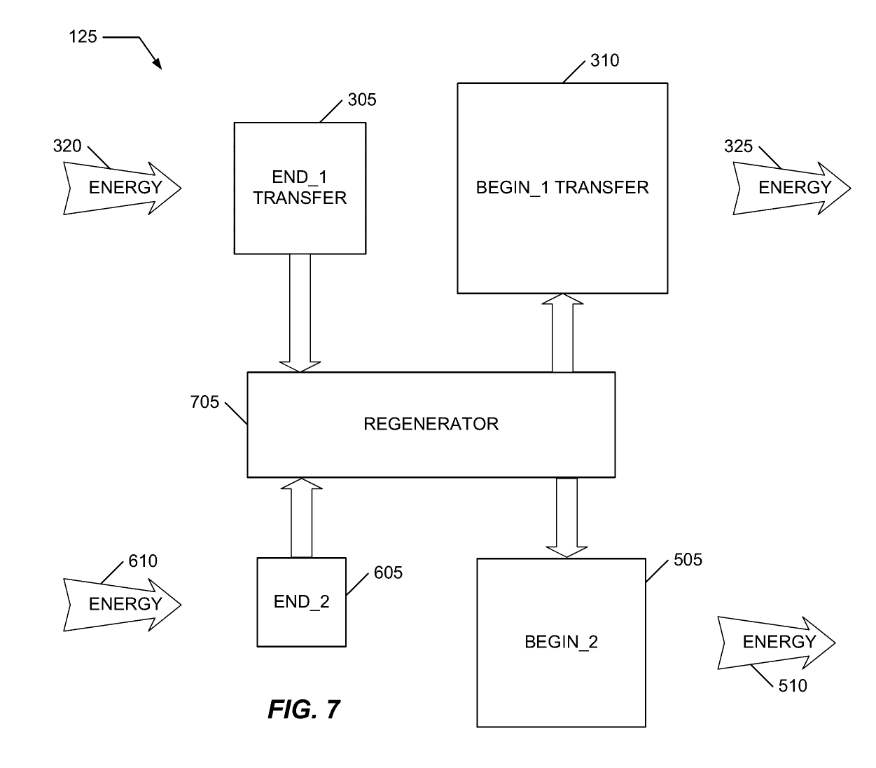

FIG. 7 illustrates an alternative switching coupler 125 as part of an alternative wireless energy transfer system 100. Switching coupler 125 illustrates a generic coupler having both branching and merging capability such as, for example, described in association with the discussion of FIG. 5 and FIG. 6—including a modified regenerator 705 to handle both merging and branching as necessary or desired. Switching coupler 125 may be predetermined or dynamic, and is coupled to multiple immediately upstream wireless transfer segments and to multiple immediately adjacent downstream wireless transfer segments. An end transfer node is coupled to each immediately adjacent upstream wireless transfer segment 120 and a begin transfer node is coupled to each immediately adjacent downstream wireless transfer segment 120.

All transfer nodes of switching intermediate coupler 125, like all other transfer nodes, preferably includes a unique correspondence to a single particular one transfer node of an immediately adjacent wireless transfer segment. This unique correspondence also preferably provides a coupling efficiency between these nodes near, at, or above the transfer threshold and all other coupling efficiencies of these nodes to non-corresponding nodes is near, at, or below the non-transfer threshold.

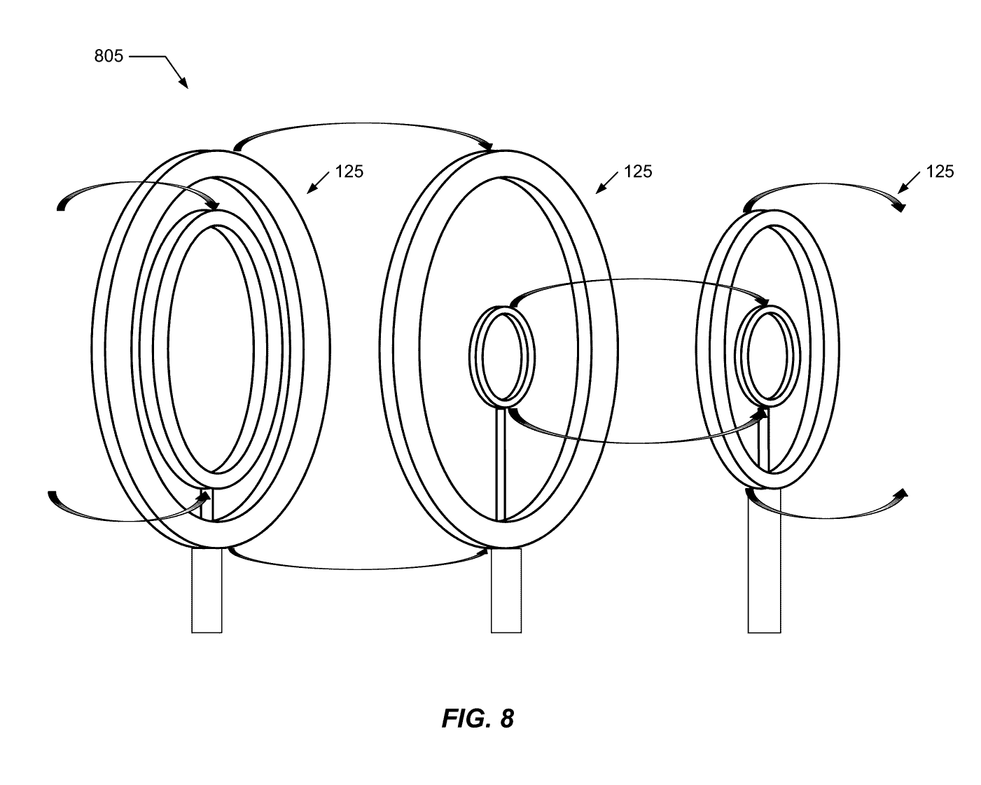

FIG. 8 illustrates a set of three intermediate couplers 125 forming a portion 805 of a wireless relay. Each coupler 125 is implemented as a ring resonator having different coupling parameters such that a resonator of an end node of any coupler 125 has a unique correspondence to a single begin node of an adjacent upstream wireless transfer segment. Similarly a resonator of a begin node of any coupler 125 has a unique correspondence to a single end node of an adjacent downstream wireless transfer segment. Non-paired transfer nodes have different coupling coefficients so no transfer is designed or intended. Matching correspondence is represented by matching radius resonators and non-matching correspondence is represented by non-matching radius resonators. As illustrated, corresponding pairs of transfer nodes have resonators of the same unique radius.

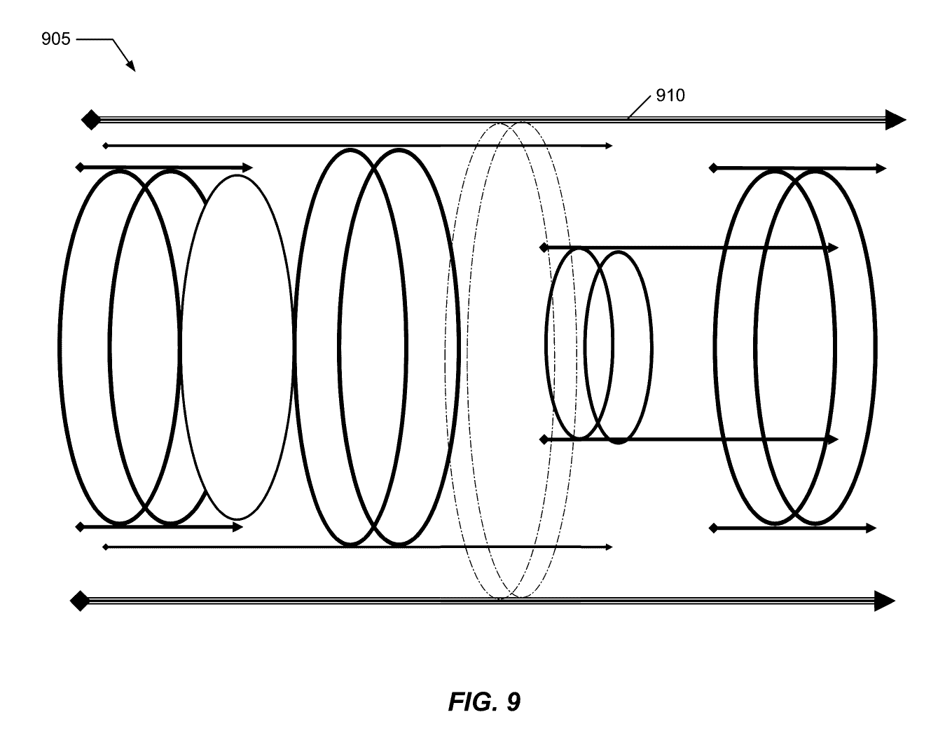

FIG. 9 illustrates a shielded implementation 905 of portion 805 including a set of three intermediate couplers with a surrounding transfer shield 910 associated with one or more wireless transfer segments. In some embodiments, it may not be possible to control wireless energy transfer impeding structures that may be distributed along a path of wireless relay 105. Some wireless transfer technologies used in one or more wireless transfer segments may be susceptible to ambient coupling which could adversely affect the desired and intended coupling efficiency between corresponding energy transfer nodes. Along a total length of wireless relay 105, or along a portion of the total length including some or all of one or more wireless transfer segments 120 particularly susceptible to ambient transfer degradation, shielding 910 encloses the total length or portion thereof. Shielding 910 is appropriate for the wireless transfer mechanism used in a relevant segment but may include a magnetic shielding, electric shielding, a combination, or other appropriate shielding. Shielding 910 inhibits, eliminates, or prevents energy transfer from a transfer node of wireless relay 105 to any outside structure.

As described in the previously referenced co-pending application, an external electrical power connection, either external to a building structure and connected directly to at least a portion of a building which is an intelligent structure, or within a building which is traditionally hard-wired to a portion of that building which is an intelligent structure.

The alternating or direct electrical current is then fed to a near-field generation element, preferably a magnetic field resonator with a particular Q factor. This resonator, to minimize the use of electrical wiring or other conventional conductive material which conducts electrons and electrical power on or in its body, is preferably located on the outer edges of a module, and furthermore, preferably in a location of the module out of the em-transfer path for display, lighting, and sensing, although the magnetic field generating resonator may itself be substantially or partly be fabricated of a transparent or substantially transparent conductive material.

Within the same module, depending on its size, or between smaller modules (noting an experimental success in the usage of paired resonator of 5m+), one or more resonators with a second Q factor are placed, but these resonators are further married and electrically connected to another resonator with a third Q factor. The multiple resonator-pairs are distinct from the first resonator, which receives power from an external electro-motive force (typically, as noted, an external power line). The Q-factors are calculated using methods known to the art, as exemplified by the published work of Joannopoulos, Karalis, and Soljacic, and the improved devices they propose include feedback mechanisms to modify Q in an individual device to account for other potentially absorptive objects in the path of resonant emission. Research has shown, coupling time for the resonator and resonant receiver are faster than the time it takes a potentially absorptive object to draw-off. This has allowed demonstration of efficient transmission through walls.

Wire loops and dielectric disks have both been employed as resonant structures. Folded-loops with the same resonant frequency provide a path well-known to the art of antenna engineering for implementing extremely compact resonators. Resonators may be designed for power transfer to autonomous nano-objects, and device features which will be required to fabricate such compact resonators can now be fabricated by various methods known to the art, including emboss-etch, and including advantageously, textile-woven structures, such as, for example, US patent number 20050201674 “SYSTEM, METHOD, AND COMPUTER PROGRAM PRODUCT FOR TEXTILE STRUCTURED WAVEGUIDE DISPLAY AND MEMORY” which is hereby expressly incorporated by reference thereto in its entirety for all purposes.

The multiple resonator-pairs may be seen as power-relay pairs, which if the contact is open between the receiving and the re-emitting pair, provides at least a portion of the input power to the output device.

Spatially, the input resonator is closer in orientation to the distant original resonator than the relay resonator; optimally, the relay pair is placed within the efficient coupling distance of the first emitter.

From the position of the original resonator, with respect to the module in which it is placed, a sphere may be understood to define a shape of the resonant field emitted by the resonator. Depending on the use of impermeable material around the resonator, this shape may be modified and tailored. But at progressive distances from the emitter, relay-pairs may be placed, where wireless power-relay paths may be desired, and pairs will be positioned to optimally receive the resonant field energy.

To implement an actual “relay” system, if no impermeable material is employed as a “shield” or any other field-shaping means is employed to avoid “crosstalk” with respect to the potentially multiple relay-pairs with respect to an original resonator, another type of relay-pair is needed, which is at a distance from any of the first type of relay pairs, and typically at a greater distance than that from the original resonator, and placed with respect to one or more of the first type of relay-pair to optimally receive the resonant energy from one or more re-emitters.

This third type of component is a relay-pair which combines a receiving resonator with a fourth Q factor and a re-emitting resonator with either the first Q factor, or a fifth Q-factor. If a fifth Q-factor, then a fourth type of relay-pair is needed, which consists of a sixth Q-factor receiver and the first Q-factor re-emitter.

The principle determining whether additional types of relay-pairs are needed is the degree to which a re-emitter will “short-circuit” the power-relay system by being bled off from an earlier receiver on the “line.” Thus, a borderline arrangement places at least one intervening, different relay-pair, between the first resonator and another re-emitting resonator with the same Q-factor, in a system with four Q-factors. Depending on materials, such an arrangement will require either magnetically impermeable shielding materials and/or field-shaping structures.

Preferably, therefore, there are sets of four elements in a line, counting an original, externally-powered resonator, and three if the original emitter is not counted.

The other devices in the intelligent system thus preferably each retain at least one, and in practice, multiple receiving-resonant structures to allow them to receive one or more frequencies of resonant field energy as transmitted by the multiple types of emitters and re-emitters, with multiple Q-factors. Each and any of these resonators are preferably also actually switchable circuits, i.e., that a critical portion of the resonant structure may be removed by either mechanical, acoustic, electrical, magnetic, electro-optic, magneto-optic, acousto-optic, or other methods known to the art which can “switch” and make resonantly-inoperative at least some sufficiently large portion of the resonator to change its Q and resonant frequency.

The power-relay devices, as is preferable with other devices deployed and distributed in the proposed intelligent structure, are preferably wirelessly addressed as well. Thus, an intelligent system can determine whether any power should be emitted at all from the original emitter, and if so, which relay nodes or power distribution vectors, intra and inter-module, should be switched “on.”

Non-volatile memory within these addressable, wirelessly-powered devices, to be accessed by a wireless addressing (preferably RFID as detailed herein, but also Bluetooth, Wi-Fi, Wi-Max, 3G, etc.) signal, which may also provide the input energy to power the circuit which tells the device to complete the circuit for the receiving-resonators.

Of course, in the case of wirelessly-addressed and powered hubs, the same scheme may be employed, with lower power levels and shorter distances employed to power and address individual devices.

The combination of wirelessly-addressing and powering of distributed arrays and individual devices within buildings will enable power and device array scaling to wall, room and building size, and beyond, such that the definition of an “array” will be expanded to blur into “network.” Leveraging the processing capacity of cheap, distributed microprocessors in display and sensor arrays as part of large networks will add overall computing and Internet switching capacity if designed to allow usage of that capacity. Arrays thus become akin to server-farms, and software may be optimized to utilize the latent capacity of nodes in large arrays, and cheap and plentiful nodes themselves can be augmented in their processing and storage capacity to provide greater contribution to computing and telecommunications tasks.

This description, with slight modification in the concluding paragraph, is found in the previously referenced co-pending application.

What is not specifically addressed are the issues that arise when attempting to extend this approach to wireless power-relay “in the open”, i.e., between buildings in a building complex or, beyond that, to intra-city wireless power relay and from there to long-distance wireless power relay.

The solutions to this problem is provided as follows, principally through a general approach to reducing undesired power absorption by structural mass that might otherwise be within the medium-range (relatively) omnidirectional resonance field of the Kurs et al/Witricity wireless powering and charging system, or even with the relatively more “shaped” space-filling resonance fields of the improved versions by Witricity/MIT researchers.

Beyond this general approach for improved efficiency and loss mitigation, an even more important proposal is made for low-frequency (propagation) resonance field “field guiding” or “wave-guiding.”

Further pointing up the contrast to the line of development pursued by Kurs et al (now through the commercial spinoff entity, Witricity), the object of wireless power relay is by its nature different in its optimization: instead of providing a room or multi-room general powering field essentially “filling the space,” such that devices arbitrarily placed in that field may, and equipped with a resonance structure tuned to resonate with that field, may be powered (or batteries charged) by that field, in a power-relay system it is NOT desired to generally permeate a space with the resonance field. It is rather oriented towards TARGETED delivery to known fixed-point devices (final objects for powering, such as spatially-dispersed device arrays) or other fixed-point nodes in a fixed power-relay system.

This goes substantially beyond attempting to tailor or shape the field more efficiently to reduce losses within the general scheme of permeating a space in a semi-shaped but still omni-directional resonance field of intended “even” density at all potential use-coordinates, supplied therefore with potential energy that devices may tap into within that space from any arbitrary location that a human user might require.

It is however a consequence of a well-designed wireless power-relay system, either within or between structures/buildings, that resonant field “hot spots” may be provided for and supported by pre-designed High-Q emitters in the power-relay network, which (by virtue of being part of an efficiently designed system) may be expected to be “designed-in” to new building structures according to known geometries and materials, and thus more efficiently tailored to a space than in the case of a Witricity-type installation in which a consumer themselves places emitter(s) in a space, without benefit of a building-designer's access to analytical optimizing tools to model the space with an optimally efficient coverage zone.

It should be apparent that a wireless-power relay system, supporting efficiently-tailored, pre-analyzed resonant-field “hot spots,” provides a corollary superior solution to permeating a space with safe wireless powering and charging of devices arbitrarily placed in spaces served by a designed wireless power-relay network.

Beyond this corollary benefit, there is another even more essential feature and benefit of the proposed “guided” power-relay system:

1. The use of low-frequency “field insulation” materials and structures to reduce lossiness in the relay process.

2. The use of low-frequency “wave/resonance field-guiding” structures and materials to more efficiently guide field energy from point to point, significantly reducing absorption losses.

3. The use of higher-intensity low-frequency resonance fields (than the Witricity type) in such controlled (insulating and guiding) structures, so that the energy density transmitted from resonator to resonator may be significantly higher and yet still safely relayed.

Some additional elaboration of the types of materials and structures to implement insulation and guiding functions and operations will further illustrate the practical implementation of the system herein proposed.

First, it is noted that in a relay system focused on relay over greater distances than within a distributed array device such as an “intelligent structural system display/sensing etc. wall” (See co-pending application, “Intelligent System”), including especially for greater distances within structures/buildings, between buildings, in cities and long distance, that relay sequences of emitter/receiver pairs will more efficiently be structured together as combined “relay pole/stations.”

For example:

1. Receiver Q1/Emitter Q2 are combined and conductively connected on a “relay pole”, such that resonant energy coupled to RQI is conducted to Emitter EQ2;

2. Receiver Q2/Emitter Q3 are combined and conductively connected on a “relay pole,” and the like;

3. Receiver Q3/Emitter Q1 are combined and conductively connected on a “relay pole,” etc.

In addition, a “configurable” or “switchable” wireless power-relay network, preferably a wirelessly controlled (or wired, less preferably) “relay station” may add one or more additional emitters of different tunings and one or more additional receivers, such that all or a portion of the power may be switched from a receiver(s) to emitter(s), with the only proviso that additional, differentiated tuning (receiver/emitter pair types) must be employed on the principle and model already disclosed, namely, that as many separately-tuned resonator/emitter pair types be employed as necessary to avoid cross-talk, with a minimum of the three tuning sets as shown above for each “branch line” from a “station.”

The greater the number of termination lines at a station, the greater the need for insulation and/or spatial separation to avoid crosstalk between pairs of the same type/tuning.

1. Structures for Shielding and Reducing Loss:

The focus here is on materials and materials systems and structures for reducing penetration of low-frequency resonance fields, given the specification in the co-pending application of using impermeable materials for this object, and to aid in the shaping of fields.

Further developing the details of implementation, it is proposed that cost-effective methods of providing for magnetic insulation and disposition of impermeable materials may be, in terms of practical materials systems, consist in either 1) thin layers of encapsulated ceramic powders embedded in composites, with an impermeability factor preferably and effectiveness such as that possessed by barium titanate or greater for conventional magnetic shielding applications; or 2) sintered or otherwise “cured” ceramic coatings of ceramics of similar quality on rigid or hard surface objects.

Shaping of fields may be further implemented by the shaping of the emitting resonant body itself (such as wire hoop(s)), benefiting from widely-understood principles of coil and other resonant and field-generating body design; and secondarily, of the use of highly-permeable materials more distantly “down” or “further along” in a relay-line, as may be coated or built-up and wrapped or composited on structures shaped such that the combination of materials which may be disposed in a space to draw flux lines into a preferred direction/vector into, such secondary “attractors” mediating between the emitter and the receiver of the two-body resonantly-coupled system. And in addition, the shaping of the matching resonant receiver itself may provide additional control over the resonant “corridor” down a relay-line.

To reduce the cost of deploying such shielding as a ceramic powder coating requiring more expensive thermal treatment or chemical solution or vapor deposition, following the teaching of co-pending application “Intelligent Structural System,” ceramic powder encapsulated or coated textile composites, advantageously affixed under controlled tension, provides a potentially more efficient method of retrofitting older structures and spaces, as well as for cheaper and more efficiently designed/controlled new structures/buildings.

2. “Wave/resonance field containment and guiding:” In this more advanced method of controlling guiding low-frequency resonant energy, periodicity is introduced into macro-scale structures to further effect lower-loss control, in addition to the use of, where possible and cost effective, relatively impermeable materials.

This periodicity may be thought of as electro-magnetic “anti-tuning fork” elements or disruptors in the field-space, bracketing a relay-line or corridor.

These may be solid structures, and themselves composed of and fabricated from multi-layers designed by materials choice and dimensions to implement a low-Q damping effect.

However, preferably (but not mutually-exclusive to any other method), the guiding structures are implemented by tensioned membrane “tubes” between “relay poles,” following the teaching of the previously referenced Intelligent Structure System already referenced and the mechanical benefits described therein.

Complex-shape controlled tensioned surfaces, treated or encapsulating materials relatively impermeable, may preferably be designed with anti-resonant loop/hoop structures in 1D surface continuous periodic pattern, fabricated to implement a theoretically calculated low-frequency resonant “bandgap” and at a minimum, Low-Q rating; furthermore, such tensioned structures may be fabricated in a “nesting” form, with gaps designed within an acceptance range to implement a 1D macro-bandgap or at least Low-Q rating. Combining conductive periodic hoop/loop structures on the surface of tubes, either of rectilinear, curvilinear or irregular/combined cross-section, as well as optionally nesting such structures, provides the potential for 2D/3D macro low-frequency resonant band-gapping/stop-gapping, which will more efficiently prevent the leaking of low-frequency resonance fields outside the guiding structure.

Prospective use of graphene (or carbon nanotube/nanotube composite filaments; see co-pending 3D fab, materials and devices therefrom application <<______>>) as a highly conductive but non-copper (and thus cost effective) conductive system may be expected to further improve the performance of this option for more efficient wireless power-relay from point to point.

Optional differential air-pressure in sealed tensioned-membrane tubes (greater or lower than exterior), as well as optional alternative cells, provide further opportunities for managing the resonance properties of the space between active “relay poles” and stations.

As detailed in the referenced co-pending Intelligent Structural System, tensioned membrane composites such as Birdair/Cabo's Tensotherm product provide, at additional expense, an even stronger tensioned membrane structural system with additional performance attributes due to the aerogel composite. Aerogel composites of different composition, tailored to the insulation (thermal, atmospheric, electrical, magnetic, solar) requirements of a particular power-relay tube structure, combined with other elements of the membrane composite (such as membrane surfaces that are UV resistant and “Self-cleaning) add further performance enhancement to the proposed system.

Shaping the tensioned membrane, including with an optional outer “airflow” optimized layer different for the operative “guiding” and/or “insulating” layer, is an option for ensuring robustness in high-wind conditions, rain or snow-loading.

Building such structures relatively close to the ground is an option that high-voltage power lines do not have, unless buried underground at substantially increased cost; lower to the ground, such structures are subject to lower winds and provide easier access to repair, should it be needed.

Color and printed pattern on the tensioned membrane can further aid in the interaction with wildlife, including for visibility; and, to increase the acceptance of this alternative power-distribution system to the general human population of different regions, they can be decorated in colorful (or subdued and “natural” ways) that integrate better into the urban or country landscape than conventional power lines.

With and between buildings, such tensioned relay-tubes can have added “intelligence” functionality built into the tensioned structural system, including distributed sensing and display, again as per the referenced co-pending “Intelligent Structural System.”

Tubes can also be buried underground and in sewer systems, treated and sealed further against greater corrosion effects of such subterranean environments.

The structural/design options for such relay-structures, enabling safer relay of low-frequency resonant power, point to point, are not limited to those listed here, and may implement or be utilized by and for the systems described in the co-pending “intelligent Structural System” and benefit from other advantages detailed therein, and beyond, in configurations and embodiments encompassed within the spirit and principles of the present disclosure.

The benefits of further investment in shielding and guiding systems may be appreciated from the following notations regarding the demonstrated base-case efficiency of the current medium-range magnetic resonant coupling power exchange of up to 90% (source: Witricity).

Further note is made of the fact that, unlike Witricity's more limited “portable-moveable emitter and omnidirectional field med-range powering system” (a more accurate description of what that system is), the present disclosure includes but is not limited to the operative “medium range” of the wireless charging and power system of the earlier referenced papers, patents and pending applications, and commercial offerings that followed the disclosure by the author of the present disclosure of the wireless device powering disclosure of 2004.

Not limited to lower-level of operating power for power-relay purposes, nor therefore limited in range, greater distances between relay poles (and stations) and thus efficiencies in numbers (and thus materials and construction time) can be obtained than would be the case from simply extrapolating the operating range from the Kurs/Witricity wireless charging system.

Most critically, therefore, the additive effects of the measures proposed can make a substantial difference in the degree to which the wireless power relay paradigm can be efficiently extended to long-distance electrical power transmission. Currently the average efficiency over the long-distance transmission portions of existing grids is estimated at 6-7%.

Real loss of the overall grid systems (which vary in age and efficiency around the world) are not a matter of the lowest-loss, high-voltage transmission lines, but the efficiency of the whole system, including corona losses at high voltage, down-stepping voltages to the sub-transmission stage and from there to the local sub-station distribution and low-voltage mains and the greater losses from local station distribution.

The efficiency of the system thus is determined by the accumulated losses.

Most estimates of the accumulated loss from the point of energy handoff to the grid up to and including the users “wall” and grounding losses are approximately between 20-30%, with about 10% loss from long distance transmission and sub-transmission and 20% from the lower-voltage stage of local power distribution.

Beginning with an unguided “free-space” demonstrated efficiency upper limit of 90% in magnetic near-field low-frequency resonant coupling, it will be evident that efficiency gains from even a relatively crude guidance and insulation system, along with improved materials technologies, the efficiency of wire-less power relay network would be expected to exceed even the maximum efficiencies of high-voltage long-distance power transmission averages.

It is also noted that, as an alternative embodiment of the present system, differing by implementation of a very low (but higher than ELF) E-M traveling wave system, a wireless POWER RELAY E-M system also solves and overcomes the limitations of system designs attempted first by Tesla and then others, which attempted to distribute higher power densities over greater distances, among other differences, as opposed to relatively lower-power per relay line and a greater number of relay stations, and further combined with suitable variations on the insulation and wave-guiding system of the magnetic resonance field-based system.

In high-density environments, in which safety and flexibility is paramount, a magnetic near-field based power relay system may be preferable; for longer distances, a low-frequency E-M power relay system may be preferable, to increase range when implementing efficient coupling.

Many hybrids and permutations are enabled, and with the implementation in cheaper materials systems such as carbon and silicon based molecular forms etc., instead of copper and other conductive metals in greater scarcity, a conversion of major portions if not substantially all of the present wired power grid, which would then be able to re-use the reclaimed copper and some other valuable materials in the process, is an economic prospect with great potential economic and design benefits, both direct and indirect including health and reduced risks from current grid instabilities and system vulnerabilities, including from expected and potential increases in solar activity levels, which also include rare but periodic CME-type events such as The Carrington Event of 1859.

Shielding of and non-resonance/tuning of resonators and/or guided/shielded antenna have the potential of implementing hybrid energy distribution systems which are safer and less vulnerable than the current wired grid. And not only less vulnerable to solar storm activity and rare but potentially dangerous CME-type events, but also from catastrophic system grid failures due to fluke but normal-magnitude storms that simply take down a high-percentage of power lines, or critical node failures that do occasionally trigger a cascade event.

From Wikipedia's list of the largest seven power outages, in terms of number of people impacted:

| | millions of | | | |
|---|---|---|---|---|
| | people | | | |
| article | affected | location | date | references |
| July 2012 India blackout | 670 | India | 30-31 Jul. 2012 | [1] |
| 2005 Java-Bali blackout | 100 | Indonesia | 18 Aug. 2005 | [2] |
| 1999 Southern Brazil | 97 | Brazil | 11 Mar. 1999 | [3] |
| blackout | | | | |
| 2009 Brazil and Paraguay | 87 | Brazil, Paraguay | 10-11 Nov. 2009 | [4] |
| blackout | | | | |
| Northeast blackout of 2003 | 55 | United States, Canada | 14-15 Aug. 2003 | [5] |
| 2003 Italy blackout | 55 | Italy, Switzerland, Austria, | 28 Sep. 2003 | [6] |
| | | Slovenia, Croatia | | |
| Northeast blackout of 1965 | 30 | United States, Canada | 9 Nov. 1965 | [7] |

Self-focusing transducers for an ultrasonic acoustic wave implementation may be included in some embodiments of energy transfer.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A wireless energy transfer system for transferring energy from an energy source to an energy drain, comprising: a wireless relay including a plurality of serially coupled wireless transmission segments defining a set of interfaces between pairs of said wireless transmission segments and further including a coupler disposed at each said interface of said set of interfaces wherein each said coupler includes a begin energy transfer node having a begin wireless transfer coupling value, an end energy transfer node having an end wireless transfer coupling value different from said begin wireless transfer coupling value configured to be non-interactive within a predetermined level wireless transfer performance with said begin wireless transfer coupling value, and a regenerator coupled to both said nodes.

2. The system of claim 1 wherein said wireless relay includes a first upstream segment having a first begin energy transfer node coupled to the energy source, said first begin energy transfer node having a first begin wireless transfer coupling value, wherein said wireless relay includes a first downstream segment at a first interface with said first upstream segment, wherein said first interface includes a first coupler having a first end energy transfer node having said first begin wireless transfer coupling value, and wherein said first coupler includes a second begin energy transfer node having a second begin wireless transfer coupling value different from said first begin wireless transfer coupling value configured to be non-interactive within a predetermined level wireless transfer performance with said first begin wireless transfer coupling value.

3. The system of claim 2 wherein said wireless relay includes a second upstream segment that includes said first downstream segment with said second upstream segment including said second begin energy transfer node having said second begin wireless transfer coupling value, wherein said wireless relay includes a second downstream segment at a second interface with said second upstream segment, wherein said second interface includes a second coupler having a second end energy transfer node having said second begin wireless transfer coupling value, and wherein said second coupler includes a third begin energy transfer node having a third begin wireless transfer coupling value different from said second begin wireless transfer coupling value configured to be non-interactive within a predetermined level wireless transfer performance with said second begin wireless transfer coupling value.

4. The system of claim 3 wherein said wireless relay includes a third upstream segment that includes said second downstream segment with said third upstream segment including said third begin energy transfer node having said third begin wireless transfer coupling value, wherein said wireless relay includes a third downstream segment at a third interface with said third upstream segment, wherein said third interface includes a third coupler having a third end energy transfer node having said third begin wireless transfer coupling value, and wherein said third coupler includes a fourth begin energy transfer node having a fourth begin wireless transfer coupling value different from said third begin wireless transfer coupling value configured to be non-interactive within a predetermined level wireless transfer performance with said third begin wireless transfer coupling value.

5. The system of claim 2 wherein said first downstream segment includes a second end energy transfer node having said second begin wireless transfer coupling value, said second end energy transfer node coupled to the energy drain.

6. The system of claim 3 wherein said second downstream segment includes a third end energy transfer node having said third begin wireless transfer coupling value, said third end energy transfer node coupled to the energy drain.

7. The system of claim 4 wherein said third downstream segment includes a fourth end energy transfer node having said fourth begin wireless transfer coupling value, said fourth end energy transfer node coupled to the energy drain.

8. The system of claim 1 wherein said wireless relay is configured for a near-field energy transfer architecture, wherein each said node includes a resonator, and wherein each said wireless transfer coupling value includes a Q-factor.

9. The system of claim 2 wherein said wireless relay is configured for a near-field energy transfer architecture, wherein each said node includes a resonator, and wherein each said wireless transfer coupling value includes a Q-factor.

10. The system of claim 3 wherein said wireless relay is configured for a near-field energy transfer architecture, wherein each said node includes a resonator, and wherein each said wireless transfer coupling value includes a Q-factor.

11. The system of claim 4 wherein said wireless relay is configured for a near-field energy transfer architecture, wherein each said node includes a resonator, and wherein each said wireless transfer coupling value includes a Q-factor.

12. The system of claim 7 wherein said wireless relay is configured for a near-field energy transfer architecture, wherein each said node includes a resonator, and wherein each said wireless transfer coupling value includes a Q-factor.

13. The system of claim 1 wherein said wireless relay includes a first upstream segment having a first begin energy transfer node, said first begin energy transfer node having a first begin wireless transfer coupling value, wherein said wireless relay includes a first downstream segment at a first interface with said first upstream segment, wherein said wireless relay includes a second downstream segment at a second interface with said first upstream segment, wherein said first interface includes a first coupler having a first end energy transfer node having said first begin wireless transfer coupling value, wherein said first coupler includes a second begin energy transfer node having a second begin wireless transfer coupling value different from said first begin wireless transfer coupling value configured to be non-interactive within a predetermined level wireless transfer performance with said first begin wireless transfer coupling value, and wherein said first coupler includes a third begin energy transfer node having a third begin wireless transfer coupling value different from said first begin wireless transfer coupling value configured to be non-interactive within a predetermined level wireless transfer performance with said first begin wireless transfer coupling value with said third begin energy transfer coupling value different from said second begin wireless transfer coupling value configured to be non-interactive within a predetermined level wireless transfer performance with said second begin wireless transfer coupling value.

14. The system of claim 1 wherein said wireless relay includes a first upstream segment having a first begin energy transfer node, said first begin energy transfer node having a first begin wireless transfer coupling value, wherein said wireless relay includes a second upstream segment having a second begin energy transfer node, said second begin energy transfer node having a second begin wireless transfer coupling value different from said first begin wireless transfer coupling value configured to be non-interactive within a predetermined level wireless transfer performance with said first begin wireless transfer coupling value, wherein said wireless relay includes a first downstream segment at a first interface with said first upstream segment and with said second upstream segment, wherein said first interface includes a first coupler having a first end energy transfer node having said first begin wireless transfer coupling value, wherein said first coupler includes a second end energy transfer node having said second begin wireless transfer coupling value, and wherein said first coupler includes a third begin energy transfer node having a third begin wireless transfer coupling value different from said first begin wireless transfer coupling value configured to be non-interactive within a predetermined level wireless transfer performance with said first begin wireless transfer coupling value with said third begin energy transfer coupling value different from said second begin wireless transfer coupling value configured to be non-interactive within a predetermined level wireless transfer performance with said second begin wireless transfer coupling value.

15. The system of claim 1 wherein said wireless relay includes a first upstream segment having a first begin energy transfer node, said first begin energy transfer node having a first begin wireless transfer coupling value, wherein said wireless relay includes a second upstream segment having a second begin energy transfer node, said second begin energy transfer node having a second begin wireless transfer coupling value different from said first begin wireless transfer coupling value configured to be non-interactive within a predetermined level wireless transfer performance with said first begin wireless transfer coupling value, wherein said wireless relay includes a first downstream segment at a first interface with said first upstream segment and with said second upstream segment, wherein said first interface includes a first coupler having a first end energy transfer node having said first begin wireless transfer coupling value, wherein said first coupler includes a second end energy transfer node having said second begin wireless transfer coupling value, wherein said first coupler includes a third begin energy transfer node having a third begin wireless transfer coupling value different from said first begin wireless transfer coupling value configured to be non-interactive within a predetermined level wireless transfer performance with said first begin wireless transfer coupling value with said third begin energy transfer coupling value different from said second begin wireless transfer coupling value configured to be non-interactive within a predetermined level wireless transfer performance with said second begin wireless transfer coupling value, and wherein said first coupler includes a fourth begin energy transfer node having a fourth begin wireless transfer coupling value different from said first begin wireless transfer coupling value configured to be non-interactive within a predetermined level wireless transfer performance with said first begin wireless transfer coupling value with said fourth begin energy transfer coupling value different from said second begin wireless transfer coupling value configured to be non-interactive within a predetermined level wireless transfer performance with said second begin wireless transfer coupling value with said fourth begin energy transfer coupling value different from said third begin wireless transfer coupling value configured to be non-interactive within a predetermined level wireless transfer performance with said third begin wireless transfer coupling value.

16. A method for transferring wirelessly energy from an energy source to an energy drain, comprising:
a) energizing a first set of begin energy transfer nodes, each said begin energy transfer node including a begin wireless transfer coupling value;
b) energizing, responsive to said energization of said first set of begin energy transfer nodes, a first set of end energy transfer nodes, each said end energy transfer node having an end wireless transfer coupling value wherein each particular single one energized end energy transfer node is energized by a single one energized begin energy transfer node having a begin wireless transfer coupling value matching said end wireless transfer coupling value of said particular single one energized end energy transfer node within an interaction range;
c) transferring energy from the energy source coupled to a specific begin energy transfer node to the energy drain coupled to a specific end energy transfer node;
wherein said wireless relay includes a set of a plurality of energized begin energy transfer nodes within said interaction range of each said energized end energy transfer nodes with all energized begin energy transfer nodes other than said single one energized begin energy transfer node of said set of said plurality of energized begin energy transfer nodes each having a begin wireless transfer coupling value different from said begin wireless transfer coupling value of said single one energized begin energy transfer node; and
wherein said wireless relay includes a set of a plurality of energized end energy transfer nodes within said interaction range of each said energized begin energy transfer nodes with all energized energy transfer nodes other than said single one energized end energy transfer node of said set of said plurality of energized end energy transfer nodes each having an end wireless transfer coupling value different from said end wireless transfer coupling value of said single one energized end energy transfer node.
